(19) United States
(12) Patent Application Publication
(10) Pub. No.: US 2011/0265342 A1
(43) Pub. Date: Nov. 3, 2011

(54) SUPERHEATED VAPOR PRE-DRYING SYSTEMS FOR LIGNITE AND METHODS FOR DRYING LIGNITE

(75) Inventors: Yongchun SHI, Jinan (CN); Bin JIANG, Jinan (CN); Long HUANG, Jinan (CN); Sheng LI, Jinan (CN); Xianhua DONG, Jinan (CN); Gang DOU, Jinan (CN); Shuai MIAO, Jinan (CN); Lei ZHANG, Jinan (CN); Guangrun WANG, Jinan (CN); Zhenguo NIU, Jinan (CN)

(73) Assignee: SHANDONG TIANLI DRYING EQUIPMENT CO., LTD., Jinan (CN)

(21) Appl. No.: 13/179,580

(22) Filed: Jul. 11, 2011

Related U.S. Application Data
(63) Continuation of application No. PCT/CN2009/001541, filed on Dec. 24, 2009.

(30) Foreign Application Priority Data
Jun. 4, 2009 (CN) 200910015752.4
Jun. 4, 2009 (CN) 200910015753.9
Jun. 4, 2009 (CN) 200920026492.6
Jun. 4, 2009 (CN) 200920026493.0

(51) Int. Cl. F26B 21/06; F26B 3/02

(52) U.S. Cl. 34/480; 34/72; 34/82

(57) ABSTRACT

A pre-drying system for lignite, including an inner heating fluid bed dryer including at least one built-in heat exchanger, a feeding device, a second discharging valve, and at least one stage of dust collecting device. The built-in heat exchanger is connected to saturated vapor, and to a condensate system. A fluid bed of the inner heating fluid bed dryer is connected to superheated vapor. Exhaust vapor of the inner heating fluid bed dryer is processed by the dust collecting device, and then a part thereof returns to the fluid bed, and another part thereof is evacuated.

### CROSS-REFERENCE TO RELATED APPLICATIONS

This application is a continuation of International Patent Application No. PCT/CN2009/001541 with an international filing date of Dec. 24, 2009, designating the United States, now pending, and further claims priority benefits to Chinese Patent Application No. 200910015753.9 filed on Jun. 4, 2009, to Chinese Patent Application No. 200920026493.0 filed on Jun. 4, 2009, to Chinese Patent Application No. 200910015752.4 filed on Jun. 4, 2009, and to Chinese Patent Application No. 200920026492.6 filed on Jun. 4, 2009. The contents of all of the aforementioned applications, including any intervening amendments thereto, are incorporated herein by reference.

### BACKGROUND OF THE INVENTION

1. Field of the Invention

The invention relates to a pre-drying system and a drying method using the same, and more particularly to a superheated vapor pre-drying system for lignite and a method of drying lignite.

2. Description of the Related Art

Conventional lignite drying methods use direct heating rotary dryers using hot gas for heating, or indirect heating rotary dryers using vapor as a heat source. However, problems with the direct heating rotary dryers are that they are easy to burn since lignite features high volatile content and thus being affected by temperature of inlet air, and have low drying efficiency and high equipment investment. As for the indirect heating rotary dryers, since they need tail gas, they are power-consuming (approximately 1350 kg vapor/1 ton water), features small stand-alone output (pre-drainage capability of lignite for a 300 MW unit is approximately 60 tons/hour), and requires parallel connection of multiple dryers. Taking safety factor into account, it is required to add nitrogen gas generation systems whereby preventing the lignite from burning during drying, which increases equipment investment.

At present, industrial application of lignite drying in China is still at an early stage. Moreover, no industrial-scale lignite pre-drying system is used in existing lignite power plants adopting pulverized coal fired boilers.

### SUMMARY OF THE INVENTION

In view of the above-described problem, it is one objective of the invention to provide a superheated vapor lignite pre-drying system that is capable of addressing the above-mentioned problems.

It is another objective of the invention to provide a drying method for a superheated vapor lignite pre-drying system that is capable of addressing the above-mentioned problems.

To achieve the above objectives, in accordance with one embodiment of the invention, provided is a lignite pre-drying system, comprising an inner heating fluid bed dryer comprising at least one built-in heat exchanger, a feeding device, a second discharging valve, and at least one stage of dust collecting device, the built-in heat exchanger is connected to saturated vapor, and to a condensate system, a fluid bed of the inner heating fluid bed dryer is connected to superheated vapor, and exhaust vapor of the inner heating fluid bed dryer is processed by the dust collecting device, and then part thereof returns to the fluid bed, and the other part thereof is evacuated.

In a class of this embodiment, the dust collecting device is two-stage, and comprises a cyclone dust separator and an electrostatic precipitator serially connected to each other, the cyclone dust separator operates to remove dust of part of the exhaust vapor and to transmit collected dry powder into a finished product area, and the other part of the exhaust stream return to the inner heating fluid bed dryer after being compressed by the pressure device.

In a class of this embodiment, the feeding device comprises a bunker, the bunker is fit with a screw conveyor, the screw conveyor is connected to a first discharging valve, and the first discharging valve s connected to the inner heating fluid bed dryer.

In a class of this embodiment, the pressure device is an air blower.

In accordance with another embodiment of the invention, provided is a drying method for a superheated vapor lignite pre-drying system, comprising: putting wet lignite containing 30%-50% water into an inner heating fluid bed dryer, leading superheated vapor into a fluid bed of the inner heating fluid bed dryer, leading saturated vapor in a built-in heat exchanger of the inner heating fluid bed dryer as a drying source, taking out the lignite and putting it into a finished product area after drying the lignite until it has required humidity by controlling time thereof in the fluid bed, carrying precipitated water produced by drying and part of materials in the fluid bed by exhaust steam of said superheated vapor in the fluid bed, removing dust via a cyclone dust separator, transmitting collected dry powder into a finished product area, compressing part of exhaust steam of the superheated vapor and transmitting it to the fluid bed as fluidizing medium of the fluid bed via an air blower, removing dust and evacuating the other part of exhaust steam of the superheated vapor via an electrostatic precipitator, and flowing back to a boiler for reuse by condensate water in the built-in heat exchanger of the inner heating fluid bed dryer.

In accordance with a further embodiment of the invention, provided is a superheated vapor lignite pre-drying system, comprising a multi-stage drying device, each stage thereof comprising a feeding device, a discharging device, and at least one stage of dust collecting device, an end of the dust collecting device transmits part of tail gas to a corresponding drying device via a pressure device, the other part of tail gas is transmitted to a next-stage drying device as a heat source, a first-stage drying device is connected to a vapor heat source, a dust collecting device of a final-stage drying device transmits part of the tail gas to a corresponding drying device via the pressure device, and other part of the tail gas is evacuated.

In a class of this embodiment, all stages of the multi-stage drying device are of the same structure, and each is an inner heating fluid bed dryer with a built-in heat exchanger, a bunker is connected to the inner heating fluid bed dryer via a screw conveyor and a first discharging valve, the inner heating fluid bed dryer is connected to a finished product area via a second discharging valve, the inner heating fluid bed dryer is connected to a two-stage dust collecting device comprising a cyclone dust separator and an electrostatic precipitator serially connected to each other, the cyclone dust separator is connected to a pressure device, the electrostatic precipitator is connected to a built-in heat exchanger of a next-stage drying device, and the pressure device is an air blower.

In a class of this embodiment, the built-in heat exchanger of the inner heating fluid bed dryer is connected to saturated vapor, and superheated vapor is connected to a fluid bed of the inner heating fluid bed dryer via a group of valves.

In accordance with still another embodiment of the invention, provided is a drying method for a superheated vapor lignite pre-drying system, comprising (1) first-stage drying: putting wet lignite containing 30%-50% water into a fluid bed of a first-stage inner heating fluid bed dryer, leading superheated vapor into a fluid bed of the first-stage inner heating fluid bed dryer, leading saturated vapor in a built-in heat exchanger of the first-stage inner heating fluid bed dryer as a drying source, taking out the lignite and putting it into a finished product area after drying the lignite until it has required humidity by controlling time thereof in the fluid bed, carrying precipitated water produced by drying and part of materials in the fluid bed by exhaust steam of said superheated vapor in the fluid bed, removing dust via a cyclone dust separator, transmitting collected dry powder into a finished product area, compressing part of exhaust steam of the superheated vapor and transmitting it to the fluid bed as drying medium of the fluid bed via an air blower, removing dust of the other part of exhaust steam of the superheated vapor via an electrostatic precipitator, the other part of exhaust steam of the superheated vapor being used as a heating medium of a built-in heat exchanger of a second-stage inner heating fluid bed dryer, and flowing back to a boiler for reuse by condensate water in the built-in heat exchanger of the first-stage inner heating fluid bed dryer, (2) second-stage drying: putting wet lignite containing 30%-50% water into a fluid bed of a second-stage inner heating fluid bed dryer, leading exhaust steam of said superheated vapor processed by the first-stage electrostatic precipitator in a built-in heat exchanger of the second-stage inner heating fluid bed dryer, taking out the lignite and putting it into a finished product area after drying the lignite until it has required humidity by controlling time thereof in the fluid bed, carrying precipitated water produced by drying and part of materials in the fluid bed by exhaust steam of said superheated vapor in the fluid bed, removing dust via a second-stage cyclone dust separator, compressing part of exhaust steam of the superheated vapor and transmitting it to a second-stage electrostatic precipitator for dust removal via a second-stage air blower, transmitting other part of exhaust steam of the superheated vapor being used as a drying medium to the second-stage inner heating fluid bed dryer, the other part of exhaust steam of the superheated vapor processed by the second-stage electrostatic precipitator being used as a heating medium of a built-in heat exchanger of a third-stage inner heating fluid bed dryer, and transmitting the other part of exhaust steam of the superheated vapor for third-stage drying, (3) other drying processes are similar to step(2), part of tail gas processed by a final-stage electrostatic precipitator flows back to a corresponding boiler for reuse, the other part thereof is evacuated.

The superheated vapor lignite pre-drying system comprises multiple stages of inner heating fluid beds serially connected to each other, the electrostatic precipitator removes dust of the exhaust vapor generated at the first stage, and then the exhaust vapor is used as a heating medium of the second-stage dryer, and capable of pre-drying lignite containing 30-50% water. A single-stage inner heating fluid bed dryer comprises the feeding device, the superheated vapor inner heating fluid bed, the cyclone dust separator, the electrostatic precipitator, a mixed-material transmission device, and a circulating air blower. Drying techniques of the inner heating fluid bed and the superheated vapor are combined: drying of the inner heating fluid bed is that the built-in heat exchanger is disposed in the fluid bed whereby providing most of heat required during drying of materials, and drying of the superheated vapor fluid bed is that superheated vapor is used as a medium in the inner heating fluid bed dryer, and contacted with the lignite whereby removing vapor and providing heat. All condensate water flows back to a boiler for reuse.

Advantages of the invention comprise: it is power-saving, all evaporated water is reused, the whole drying process is under an environment without oxygen, which is safe and reliable, and it ensures continuous operation since it can be seamlessly connected to auxiliary techniques in existing power plants; it can reduce power consumption in the thermal electricity industry, since most superheated vapor lignite pre-drying techniques are advantageous over conventional hot wind drying technique and indirect vapor drying technique, which greatly improves technical economical index and makes the invention have wide application prospect; moreover, the superheated vapor lignite pre-drying method plays an important role in technical upgrading and innovation, energy conservation, and emission reduction of the electric power industry, and is an environmentally-friendly, water-saving and cleaning lignite project.

### BRIEF DESCRIPTION OF THE DRAWINGS

FIG. 1 is a schematic view of a one-stage superheated vapor lignite pre-drying system of an exemplary embodiment of the invention;

FIG. 2 is a schematic view of a two-stage superheated vapor lignite pre-drying system of an exemplary embodiment of the invention;

FIG. 3 is a schematic view of a three-stage superheated vapor lignite pre-drying system of an exemplary embodiment of the invention; and

FIG. 4 is a schematic view of a three-stage superheated vapor lignite pre-drying system of another exemplary embodiment of the invention;

In the drawings, the following reference numbers are used:
1. bunker; 2. screw conveyor; 3. first discharging valve; 4. inner heating fluid bed dryer; 5. second discharging valve; 6. cyclone dust separator; 7. third discharging valve; 8. electrostatic precipitator; 9. air blower.

### DETAILED DESCRIPTION OF THE EMBODIMENTS

Detailed description of the invention will be given below in conjunction with accompanying drawings and specific embodiments.

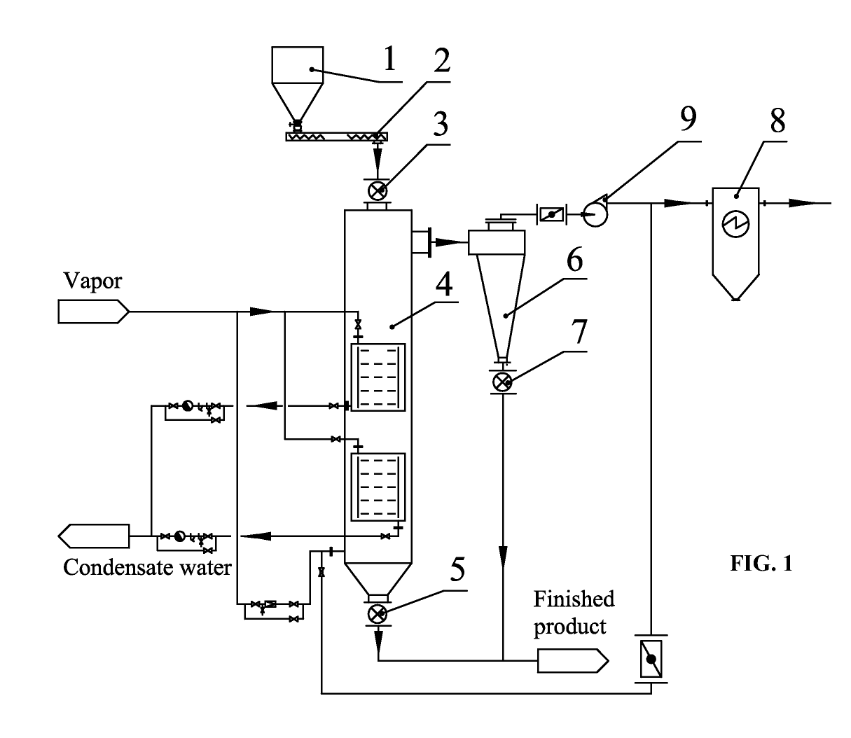

As shown in FIG. 1, a superheated vapor lignite pre-drying system of a first embodiment of the invention comprises an inner heating fluid bed dryer 4, and at least one built-in heat exchanger is disposed in the inner heating fluid bed dryer 4. A fluid bed of the inner heating fluid bed dryer 4 is connected to superheated vapor, and the built-in heat exchanger is connected to saturated vapor. A first discharging valve 3 is disposed at the top of the inner heating fluid bed dryer 4, and connected to a screw conveyor 2. The screw conveyor 2 is fit with a bunker 1. A second discharging valve 5 is disposed at the bottom of the inner heating fluid bed dryer 4, and produced dry powder enters a finished product area via the second discharging valve 5. Meanwhile, dry powder collected by a cyclone dust separator 6 enters the finished product area via a third discharging valve 7 at the bottom of the cyclone dust separator 6. After the cyclone dust separator 6 removes dust of exhaust vapor, part of the exhaust vapor returns to the fluid bed via the blower 9, and the other part thereof is evacuated via the electrostatic precipitator 8.

A drying method for the superheated vapor lignite pre-drying system is:

Wet lignite containing 30%-50% water is put into a feeding hole of the inner heating fluid bed dryer 4 via the screw conveyor 2 and the first discharging valve 3, and enters the fluid bed, superheated vapor is led into the fluid bed via a wind chamber at the bottom of the inner heating fluid bed, and then into a bed layer after being distributed via a wind distribution device. During this period, the superheated vapor entering the bed layer is affectively controlled whereby maintaining fluidization of materials in the fluid bed. In the fluid bed, the lignite is heated and dried by heat provided by the built-in heat exchanger and the superheated vapor, after the lignite is dried until it has required humidity by controlling time thereof in the fluid bed, the lignite is output via the second discharging valve 5 disposed at a discharging hole of the fluid bed dryer, and transmitted to the next process along with dry powder collected via the third discharging valve 7 below the cyclone dust separator 6. Precipitated water and part of materials are carried by the superheated vapor in the fluid bed, and flows out from the inner heating fluid bed dryer 4, and dust thereof is removed via the cyclone dust separator 6, part of exhaust steam of the superheated vapor is compressed via the air blower 9 and transmitted to the wind chamber of the inner heating fluid bed dryer 4, and operates as a drying medium, and dust of the other part thereof is removed by a first-stage electrostatic precipitator 8 and discharged. Condensate water in the built-in heat exchanger of the inner heating fluid bed dryer 4 flows back to a boiler for reuse.

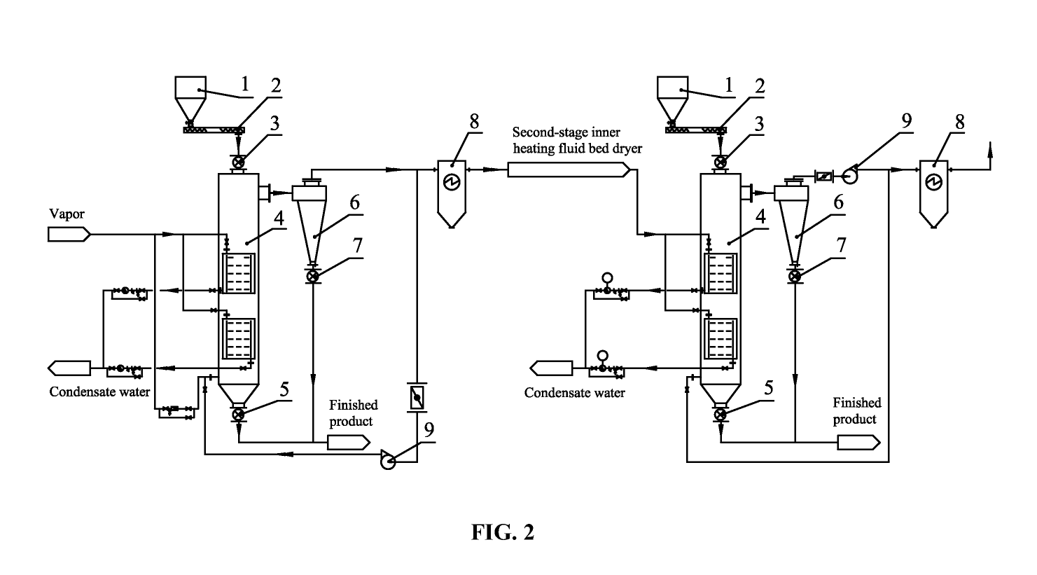

As shown in FIG. 2, a superheated vapor lignite pre-drying system of a second embodiment of the invention comprises two stages of inner heating fluid bed dryers 4, and at least one built-in heat exchanger is disposed in each stage of the inner heating fluid bed dryers 4. A bunker 1 is connected to the inner heating fluid bed dryer 4 via a screw conveyor 2 and a first discharging valve 3, and the inner heating fluid bed dryer 4 is connected to a finished product area via a second discharging valve 5. A cyclone dust separator 6 and an electrostatic precipitator 8 are serially connected to the inner heating fluid bed dryer 4. A built-in heat exchanger of a first-stage inner heating fluid bed dryer 4 is connected to saturated vapor, and a fluid bed thereof is connected to superheated vapor. Part of tail gas of a cyclone dust separator 6 of the first-stage inner heating fluid bed dryer 4 is compressed via an air blower 9, and transmitted to the fluid bed of the first-stage inner heating fluid bed dryer 4, and the other part thereof passes the electrostatic precipitator 8, and then is transmitted to a built-in heat exchanger of a second-stage inner heating dryer as a heat source. Part of tail gas of a cyclone dust separator 6 of the second-stage inner heating fluid bed dryer 4 is transmitted to the second-stage inner heating fluid bed dryer 4 via the air blower 9, and the other part thereof passes the electrostatic precipitator 8 and then is discharged.

A first-stage drying method for the superheated vapor lignite pre-drying system is:

Wet lignite containing 30%-50% water is put into a feeding hole of the first-stage inner heating fluid bed dryer 4 via the screw conveyor 2 and the first discharging valve 3, and enters the fluid bed, superheated vapor is led into the fluid bed via a wind chamber at the bottom of the inner heating fluid bed, and then into a bed layer after being distributed via a wind distribution device. During this period, the superheated vapor entering the bed layer is affectively controlled whereby maintaining fluidization of materials in the fluid bed. In the fluid bed, the lignite is heated and dried by heat provided by the built-in heat exchanger and the superheated vapor, after the lignite is dried until it has required humidity by controlling time thereof in the fluid bed, the lignite is output via the second discharging valve 5 disposed at a discharging hole of the fluid bed dryer, and transmitted to the next process along with dry powder collected via the third discharging valve 7 below the cyclone dust separator 6. Precipitated water and part of materials are carried by the superheated vapor in the fluid bed, and flows out from the first-stage inner heating fluid bed dryer 4, and dust thereof is removed via the cyclone dust separator 6, part of exhaust steam of the superheated vapor is compressed via the air blower 9 and transmitted to the wind chamber of the first-stage inner heating fluid bed dryer 4, and operates as a drying medium, and dust of the other part thereof is removed by the electrostatic precipitator 8, and operates as a drying medium for a built-in heat exchanger of a second-stage inner heating fluid bed dryer 4. Condensate water in the built-in heat exchanger of the first-stage inner heating fluid bed dryer 4 flows back to a boiler for reuse.

A second-stage drying method for the superheated vapor lignite pre-drying system is:

Wet lignite containing 30%-50% water is put into a feeding hole of the second-stage inner heating fluid bed dryer 4 via the screw conveyor 2 and the first discharging valve 3, and enters the fluid bed. Superheated vapor discharged from the electrostatic precipitator 8 of the first-stage inner heating fluid bed dryer 4 is led into the built-in heat exchanger of the second-stage inner heating fluid bed 4 as a heat medium, whereby exchanging heat of materials and generating superheated vapor. The superheated vapor is led into the cyclone dust separator 6 for removing dust. Part of the superheated vapor is compressed via the air blower 9, and enters the fluid bed via the wind chamber at the bottom of the second-stage inner heating fluid bed dryer 4 as a heat medium, and then enters a bed layer after being distributed via a wind distribution device. During this period, the superheated vapor entering the bed layer is affectively controlled whereby maintaining fluidization of materials in the fluid bed. Vapor required by the built-in heat exchanger of the second-stage inner heating fluid bed dryer 4 is provided by the electrostatic precipitator 8 of the first-stage inner heating fluid bed dryer 4.

In the fluid bed, the lignite is heated and dried by heat provided by the built-in heat exchanger and the superheated vapor (gas used by the fluid bed for circulation is the superheated vapor, in the drawings, the superheated vapor is gas compressed via the air blower and enters the fluid bed dryer, and gas in the whole system is the superheated vapor), after the lignite is dried until it has required humidity by controlling time thereof in the fluid bed, the lignite is output via the second discharging valve 5 disposed at a discharging hole of the fluid bed dryer, and transmitted to the next process along with dry powder collected via the third discharging valve 7 below the cyclone dust separator 6. Precipitated water and part of materials are carried by the superheated vapor in the fluid bed, and flows out from the second-stage inner heating fluid bed dryer 4, and dust thereof is removed via the cyclone dust separator 6, part of exhaust steam of the superheated vapor is compressed via the air blower 9 and transmitted to the fluid bed, and dust of the other part thereof is removed by the electrostatic precipitator 8, and then discharged.

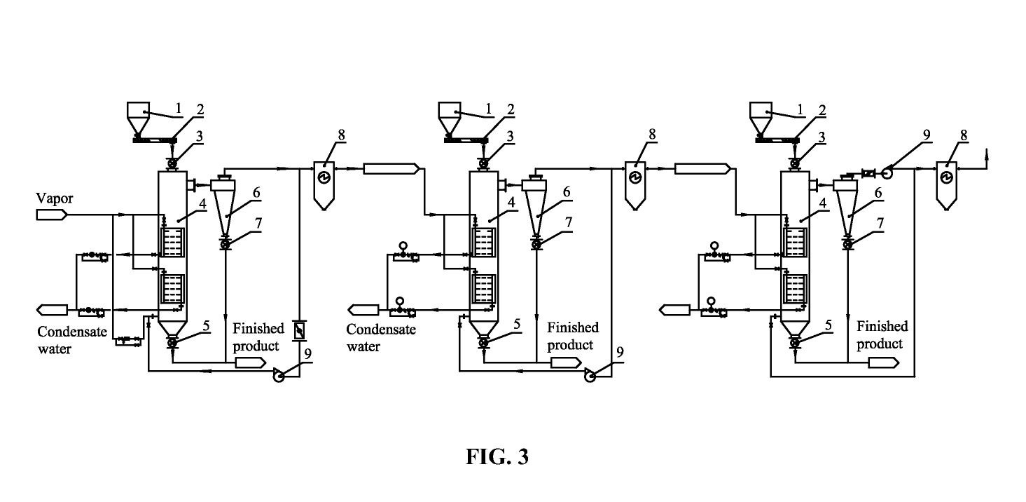

As shown in FIG. 3, a superheated vapor lignite pre-drying system of a third embodiment of the invention comprises three stages of inner heating fluid bed dryers 4, and at least one built-in heat exchanger is disposed in each stage of the inner heating fluid bed dryers 4. A bunker 1 is connected to the inner heating fluid bed dryer 4 via a screw conveyor 2 and a first discharging valve 3, and the inner heating fluid bed dryer 4 is connected to a finished product area via a second discharging valve 5. A cyclone dust separator 6 and an electrostatic precipitator 8 are serially connected to the inner heating fluid bed dryer 4. A built-in heat exchanger of a first-stage inner heating fluid bed dryer 4 is connected to saturated vapor, and a fluid bed thereof is connected to superheated vapor. Part of tail gas of a cyclone dust separator 6 of the first-stage inner heating fluid bed dryer 4 is compressed via an air blower 9, and transmitted to the fluid bed of the first-stage inner heating fluid bed dryer 4, and the other part thereof passes the electrostatic precipitator 8, and then is transmitted to a built-in heat exchanger of a second-stage inner heating dryer as a heat source after dust is removed thereby. Part of tail gas of a cyclone dust separator 6 of the second-stage inner heating fluid bed dryer 4 is transmitted to the fluid bed of the second-stage inner heating fluid bed dryer 4 via the air blower 9, and the other part thereof passes the electrostatic precipitator 8, and then to the built-in heat exchanger of a third-stage inner heating dryer 4 after dust is removed thereby. Part of tail gas of a cyclone dust separator 6 of the third-stage inner heating fluid bed dryer 4 is transmitted to the fluid bed of the third-stage inner heating fluid bed dryer 4 via the air blower 9, and the other part thereof passes the electrostatic precipitator 8, and is discharged after dust is removed thereby.

A first-stage drying method for the superheated vapor lignite pre-drying system is:

Wet lignite containing 30%-50% water is put into a feeding hole of the first-stage inner heating fluid bed dryer 4 via the screw conveyor 2 and the first discharging valve 3, and enters the fluid bed, superheated vapor is led into the fluid bed via a wind chamber at the bottom of the inner heating fluid bed, and then into a bed layer after being distributed via a wind distribution device. During this period, the superheated vapor entering the bed layer is affectively controlled whereby maintaining fluidization of materials in the fluid bed. In the fluid bed, the lignite is heated and dried by heat provided by the built-in heat exchanger and the superheated vapor, after the lignite is dried until it has required humidity by controlling time thereof in the fluid bed, the lignite is output via the second discharging valve 5 disposed at a discharging hole of the fluid bed dryer, and transmitted to the next process along with dry powder collected via the third discharging valve 7 below the cyclone dust separator 6. Precipitated water and part of materials are carried by the superheated vapor in the fluid bed, and flows out from the first-stage inner heating fluid bed dryer 4, and dust thereof is removed via the cyclone dust separator 6, part of exhaust steam of the superheated vapor is compressed via the air blower 9 and transmitted to the wind chamber of the first-stage inner heating fluid bed dryer 4, and operates as a drying medium, and dust of the other part thereof is removed by the electrostatic precipitator 8, and operates as a heating medium for a built-in heat exchanger of a second-stage inner heating fluid bed dryer 4. Condensate water in the built-in heat exchanger of the first-stage inner heating fluid bed dryer 4 flows back to a boiler for reuse.

A second-stage drying method for the superheated vapor lignite pre-drying system is:

Wet lignite containing 30%-50% water is put into a feeding hole of the second-stage inner heating fluid bed dryer 4 via the screw conveyor 2 and the first discharging valve 3, and enters the fluid bed. Superheated vapor discharged from the electrostatic precipitator 8 of the first-stage inner heating fluid bed dryer 4 operates as a heat medium of the built-in heat exchanger of the second-stage inner heating fluid bed 4. Superheated vapor generated by heating materials via the built-in heat exchanger is led into the cyclone dust separator 6 for removing dust. Part of the superheated vapor is compressed via the air blower 9, and enters the fluid bed via the wind chamber at the bottom of the second-stage inner heating fluid bed dryer 4 as a heat medium, and then enters a bed layer after being distributed via a wind distribution device. During this period, the superheated vapor entering the bed layer is affectively controlled whereby maintaining fluidization of materials in the fluid bed. Vapor required by the built-in heat exchanger of the second-stage inner heating fluid bed dryer 4 is provided by the electrostatic precipitator 8 of the first-stage inner heating fluid bed dryer 4.

In the fluid bed, the lignite is heated and dried by heat provided by the built-in heat exchanger and the superheated vapor, after the lignite is dried until it has required humidity by controlling time thereof in the fluid bed, the lignite is output via the second discharging valve 5 disposed at a discharging hole of the fluid bed dryer, and transmitted to the next process along with dry powder collected via the third discharging valve 7 below the cyclone dust separator 6. Precipitated water and part of materials are carried by the superheated vapor in the fluid bed, and flows out from the second-stage inner heating fluid bed dryer 4, and dust thereof is removed via the cyclone dust separator 6, part of exhaust steam of the superheated vapor is compressed via the air blower 9 and transmitted to the fluid bed, and other part thereof is transmitted to the electrostatic precipitator 8 for dust removal, and then to the third-stage drying process as a drying medium.

A third-stage drying method for the superheated vapor lignite pre-drying system is:

Wet lignite containing 30%-50% water is put into a feeding hole of the third-stage inner heating fluid bed dryer 4 via the screw conveyor 2 and the first discharging valve 3, and enters the fluid bed. Superheated vapor discharged from the electrostatic precipitator 8 of the first-stage inner heating fluid bed dryer 4 operates as a heat medium of the built-in heat exchanger of the second-stage inner heating fluid bed 4. Superheated vapor generated by heating materials via the built-in heat exchanger is led into the cyclone dust separator 6 for removing dust. Part of the superheated vapor is compressed via the air blower 9, and enters the fluid bed via the wind chamber at the bottom of the second-stage inner heating fluid bed dryer 4 as a heat medium, and then enters a bed layer after being distributed via a wind distribution device. During this period, the superheated vapor entering the bed layer is affectively controlled whereby maintaining fluidization of materials in the fluid bed. Vapor required by the built-in heat exchanger of the third-stage inner heating fluid bed dryer 4 is provided by the electrostatic precipitator 8 of the second-stage inner heating fluid bed dryer 4.

In the fluid bed, the lignite is heated and dried by heat provided by the built-in heat exchanger and the superheated vapor, after the lignite is dried until it has required humidity by controlling time thereof in the fluid bed, the lignite is output via the second discharging valve 5 disposed at a discharging hole of the fluid bed dryer, and transmitted to the next process along with dry powder collected via the third discharging valve 7 below the cyclone dust separator 6. Precipitated water and part of materials are carried by the superheated vapor in the fluid bed, and flows out from the third-stage inner heating fluid bed dryer 4, and dust thereof is removed via the cyclone dust separator 6, part of exhaust steam of the superheated vapor is compressed via the air blower 9 and transmitted to the third-stage inner heating fluid bed dryer 4, and other part thereof is transmitted to the electrostatic precipitator 8 for dust removal, and then discharged.

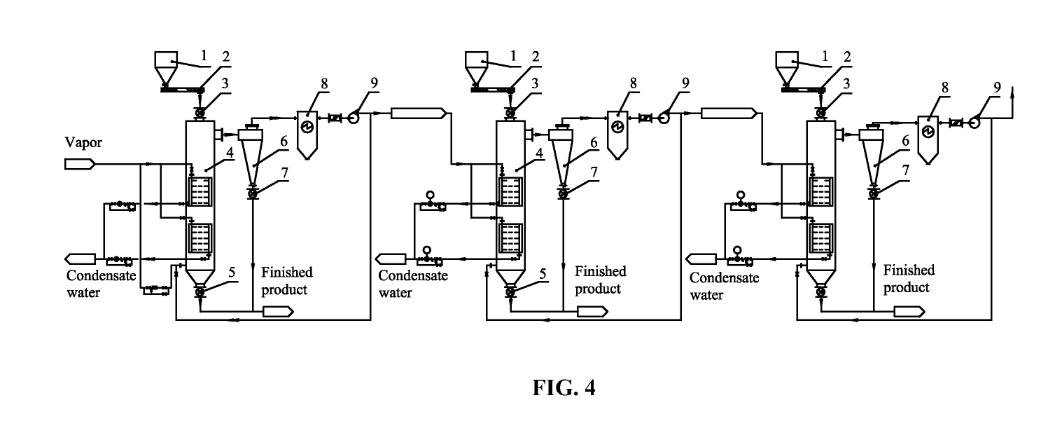

As shown in FIG. 4, a superheated vapor lignite pre-drying system of a fourth embodiment of the invention comprises three stages of inner heating fluid bed dryers 4, and at least one built-in heat exchanger is disposed in each stage of the inner heating fluid bed dryers 4. A bunker 1 is connected to the inner heating fluid bed dryer 4 via a screw conveyor 2 and a first discharging valve 3, and the inner heating fluid bed dryer 4 is connected to a finished product area via a second discharging valve 5. A cyclone dust separator 6 and an electrostatic precipitator 8 are serially connected to the inner heating fluid bed dryer 4. A built-in heat exchanger of a first-stage inner heating fluid bed dryer 4 is connected to saturated vapor, and a fluid bed thereof is connected to superheated vapor. Part of tail gas of a cyclone dust separator 6 and the electrostatic precipitator 8 of the first-stage inner heating fluid bed dryer 4 is compressed via an air blower 9, and transmitted to the wind chamber of the first-stage inner heating fluid bed dryer 4, and the other part is transmitted to a built-in heat exchanger of a second-stage inner heating dryer as a heat source. Part of tail gas of a cyclone dust separator 6 and the electrostatic precipitator 8 of the second-stage inner heating fluid bed dryer 4 is transmitted to the wind chamber of the second-stage inner heating fluid bed dryer 4 via the air blower 9, and the other part thereof is transmitted to the built-in heat exchanger of a third-stage inner heating dryer 4. Part of tail gas of a cyclone dust separator 6 and the electrostatic precipitator 8 of the third-stage inner heating fluid bed dryer 4 is transmitted to the wind chamber of the third-stage inner heating fluid bed dryer 4 via the air blower 9, and the other part thereof is discharged.

A first-stage drying method for the superheated vapor lignite pre-drying system is:

Wet lignite containing 30%-50% water is put into a feeding hole of the first-stage inner heating fluid bed dryer 4 via the screw conveyor 2 and the first discharging valve 3, and enters the fluid bed, superheated vapor is led into the fluid bed via a wind chamber at the bottom of the inner heating fluid bed, and then into a bed layer after being distributed via a wind distribution device. During this period, the superheated vapor entering the bed layer is affectively controlled whereby maintaining fluidization of materials in the fluid bed. In the fluid bed, the lignite is heated and dried by heat provided by the built-in heat exchanger and the superheated vapor, after the lignite is dried until it has required humidity by controlling time thereof in the fluid bed, the lignite is output via the second discharging valve 5 disposed at a discharging hole of the fluid bed dryer, and transmitted to the next process along with dry powder collected via the third discharging valve 7 below the cyclone dust separator 6. Precipitated water and part of materials are carried by the superheated vapor in the fluid bed, and flows out from the first-stage inner heating fluid bed dryer 4, and dust thereof is removed via the cyclone dust separator 6 and the electrostatic precipitator 8, part of exhaust steam of the superheated vapor is compressed via the air blower 9 and transmitted to the wind chamber of the first-stage inner heating fluid bed dryer 4, and operates as a drying medium, and the other part thereof operates as a heat medium for a built-in heat exchanger of the second-stage inner heating fluid bed dryer 4. Condensate water in the built-in heat exchanger of the first-stage inner heating fluid bed dryer 4 flows back to a boiler for reuse.

A second-stage drying method for the superheated vapor lignite pre-drying system is:

Wet lignite containing 30%-50% water is put into a feeding hole of the second-stage inner heating fluid bed dryer 4 via the screw conveyor 2 and the first discharging valve 3, and enters the fluid bed. Superheated vapor discharged from the air blower 9 of the first-stage inner heating fluid bed dryer 4 operates as a heat medium of the built-in heat exchanger of the second-stage inner heating fluid bed 4. Superheated vapor generated by heating materials via the built-in heat exchanger is compressed via the air blower 9 after dust thereof are removed by the cyclone dust separator 6 and the electrostatic precipitator 8, part of the superheated vapor enters the fluid bed via the wind chamber at the bottom of the second-stage inner heating fluid bed dryer 4 as a heat medium, and then enters a bed layer after being distributed via a wind distribution device. During this period, the superheated vapor entering the bed layer is affectively controlled whereby maintaining fluidization of materials in the fluid bed. Vapor required by the built-in heat exchanger of the second-stage inner heating fluid bed dryer 4 is provided by the air blower 9 of the first-stage inner heating fluid bed dryer 4.

In the fluid bed, the lignite is heated and dried by heat provided by the built-in heat exchanger and the superheated vapor, after the lignite is dried until it has required humidity by controlling time thereof in the fluid bed, the lignite is output via the second discharging valve 5 disposed at a discharging hole of the fluid bed dryer, and transmitted to the next process along with dry powder collected via the third discharging valve 7 below the cyclone dust separator 6. Precipitated water and part of materials are carried by the superheated vapor in the fluid bed, and flows out from the second-stage inner heating fluid bed dryer 4, and dust thereof is removed via the cyclone dust separator 6 and the electrostatic precipitator 8, part of exhaust steam of the superheated vapor is compressed via the air blower 9 and transmitted to the second-stage inner heating fluid bed dryer 4, and other part thereof is transmitted to the third-stage drying process as a heat medium.

A third-stage drying method for the superheated vapor lignite pre-drying system is:

Wet lignite containing 30%-50% water is put into a feeding hole of the third-stage inner heating fluid bed dryer 4 via the screw conveyor 2 and the first discharging valve 3, and enters the fluid bed. Superheated vapor discharged from the air blower 9 of the second-stage inner heating fluid bed dryer 4 operates as a heat medium of the built-in heat exchanger of the second-stage inner heating fluid bed 4. Superheated vapor is generated by heating materials via the built-in heat exchanger. The superheated vapor is compressed via the air blower 9 after dust thereof is removed via the cyclone dust separator 6 and the electrostatic precipitator 8. Part of the superheated vapor enters the fluid bed via the wind chamber at the bottom of the third-stage inner heating fluid bed dryer 4, and then enters a bed layer after being distributed via a wind distribution device. During this period, the superheated vapor entering the bed layer is affectively controlled whereby maintaining fluidization of materials in the fluid bed. Vapor required by the built-in heat exchanger of the third-stage inner heating fluid bed dryer 4 is provided by the air blower 9 of the second-stage inner heating fluid bed dryer 4.

In the fluid bed, the lignite is heated and dried by heat provided by the built-in heat exchanger and the superheated vapor, after the lignite is dried until it has required humidity by controlling time thereof in the fluid bed, the lignite is output via the second discharging valve 5 disposed at a discharging hole of the fluid bed dryer, and transmitted to the next process along with dry powder collected via the third discharging valve 7 below the cyclone dust separator 6. Precipitated water and part of materials are carried by the superheated vapor in the fluid bed, and flows out from the third-stage inner heating fluid bed dryer 4, and is compressed via the air blower 9 after dust thereof is removed via the cyclone dust separator 6 and the electrostatic precipitator 8, part of exhaust steam of the superheated vapor is transmitted to the third-stage inner heating fluid bed dryer 4, and other part thereof is discharged.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A system for drying lignite, comprising an inner heating fluid bed dryer comprising at least one built-in heat exchanger, a feeding device, a second discharging valve, and at least one stage of dust collecting device;
wherein
said built-in heat exchanger is connected to saturated vapor, and to a condensate system;
a fluid bed of said inner heating fluid bed dryer is connected to superheated vapor; and
exhaust vapor of said inner heating fluid bed dryer is processed by said dust collecting device, and then part thereof returns to said fluid bed, and the other part thereof is evacuated.

2. The system of claim 1, wherein
said dust collecting device is two-stage, and comprises a cyclone dust separator and an electrostatic precipitator serially connected to each other;
said cyclone dust separator operates to remove dust of part of said exhaust vapor and to transmit collected dry powder into a finished product area; and
the other part of said exhaust stream return to said inner heating fluid bed dryer after being compressed by said pressure device.

3. The system of claim 1, wherein
said feeding device comprises a bunker;
said bunker is fit with a screw conveyor;
said screw conveyor is connected to a first discharging valve; and
said first discharging valve s connected to said inner heating fluid bed dryer.

4. The system of claim 1, wherein said pressure device is an air blower

5. A method for drying lignite, comprising:
putting wet lignite containing 30%-50% water into an inner heating fluid bed dryer;
leading superheated vapor into a fluid bed of said inner heating fluid bed dryer;
leading saturated vapor in a built-in heat exchanger of said inner heating fluid bed dryer as a drying source;
taking out said lignite and putting it into a finished product area after drying said lignite until it has required humidity by controlling time thereof in said fluid bed;
carrying precipitated water produced by drying and part of materials in said fluid bed by exhaust steam of said superheated vapor in said fluid bed;
removing dust via a cyclone dust separator;
transmitting collected dry powder into a finished product area;
compressing part of exhaust steam of said superheated vapor and transmitting it to said fluid bed as fluidizing medium of said fluid bed via an air blower;
removing dust and evacuating the other part of exhaust steam of said superheated vapor via an electrostatic precipitator; and
flowing back to a boiler for reuse by condensate water in said built-in heat exchanger of said inner heating fluid bed dryer.

6. A system for drying lignite, comprising
a multi-stage drying device, each stage thereof comprising a feeding device, a discharging device, and at least one stage of dust collecting device;
wherein
an end of said dust collecting device transmits part of tail gas to a corresponding drying device via a pressure device;
the other part of tail gas is transmitted to a next-stage drying device as a heat source;
a first-stage drying device is connected to a vapor heat source;
a dust collecting device of a final-stage drying device transmits part of said tail gas to a corresponding drying device via said pressure device; and
other part of said tail gas is evacuated.

7. The system of claim 6, wherein
all stages of said multi-stage drying device are of the same structure, and each is an inner heating fluid bed dryer with a built-in heat exchanger;
a bunker is connected to said inner heating fluid bed dryer via a screw conveyor and a first discharging valve;
said inner heating fluid bed dryer is connected to a finished product area via a second discharging valve;
said inner heating fluid bed dryer is connected to a two-stage dust collecting device comprising a cyclone dust separator and an electrostatic precipitator serially connected to each other;
said cyclone dust separator is connected to a pressure device;
said electrostatic precipitator is connected to a built-in heat exchanger of a next-stage drying device; and
said pressure device is an air blower.

8. The system of claim 7, wherein
said built-in heat exchanger of said inner heating fluid bed dryer is connected to saturated vapor; and
superheated vapor is connected to a fluid bed of said inner heating fluid bed dryer via a group of valves.

9. A method for drying lignite, comprising
(1) first-stage drying: putting wet lignite containing 30%-50% water into a fluid bed of a first-stage inner heating fluid bed dryer;
leading superheated vapor into a fluid bed of said first-stage inner heating fluid bed dryer;
leading saturated vapor in a built-in heat exchanger of said first-stage inner heating fluid bed dryer as a drying source;
taking out said lignite and putting it into a finished product area after drying said lignite until it has required humidity by controlling time thereof in said fluid bed;
carrying precipitated water produced by drying and part of materials in said fluid bed by exhaust steam of said superheated vapor in said fluid bed;
removing dust via a cyclone dust separator;
transmitting collected dry powder into a finished product area;
compressing part of exhaust steam of said superheated vapor and transmitting it to said fluid bed as a drying medium of said fluid bed via an air blower;
removing dust of the other part of exhaust steam of said superheated vapor via an electrostatic precipitator, said other part of exhaust steam of said superheated vapor being used as a heating medium of a built-in heat exchanger of a second-stage inner heating fluid bed dryer; and
flowing back to a boiler for reuse by condensate water in said built-in heat exchanger of said first-stage inner heating fluid bed dryer;
(2) second-stage drying: putting wet lignite containing 30%-50% water into a fluid bed of a second-stage inner heating fluid bed dryer;
leading exhaust steam of said superheated vapor processed by said first-stage electrostatic precipitator in a built-in heat exchanger of said second-stage inner heating fluid bed dryer;
taking out said lignite and putting it into a finished product area after drying said lignite until it has required humidity by controlling time thereof in said fluid bed;
carrying precipitated water produced by drying and part of materials in said fluid bed by exhaust steam of said superheated vapor in said fluid bed;
removing dust via a second-stage cyclone dust separator;
compressing part of exhaust steam of said superheated vapor and transmitting it to a second-stage electrostatic precipitator for dust removal via a second-stage air blower;
transmitting other part of exhaust steam of said superheated vapor being used as a drying medium to said second-stage inner heating fluid bed dryer, said other part of exhaust steam of said superheated vapor processed by said second-stage electrostatic precipitator being used as a heating medium of a built-in heat exchanger of a third-stage inner heating fluid bed dryer; and
transmitting said other part of exhaust steam of said superheated vapor for third-stage drying;
(3) other drying processes are similar to step(2), part of tail gas processed by a final-stage electrostatic precipitator flows back to a corresponding boiler for reuse, the other part thereof is evacuated.
